(19) United States
(12) Patent Application Publication
(10) Pub. No.: US 2009/0084750 A1
(43) Pub. Date: Apr. 2, 2009

(54) DECORATING BOTTLE CAPABLE OF EXPANDING PATTERNS ON INNER BOTTLE BODY

(76) Inventor: Juo-Shan Wu, Taipei City (TW)

Correspondence Address: Juo-Shan Wu, 235 Chung - Ho, Box 8-24, Taipei, 235, TW

(21) Appl. No.: 11/865,077

(22) Filed: Oct. 1, 2007

(51) Int. Cl. B65D 1/04; B23P 19/04; B65D 85/00

(52) U.S. Cl. 215/6; 206/457; 29/700

(57) ABSTRACT

A decorating bottle capable of expanding patterns on an inner bottle body comprises an inner bottle having a pattern at an outer surface thereof; an outer bottle at an outer side of the inner bottle; a hollow space being formed between the inner bottle and the outer bottle; the outer bottle made of transparent material or semi-transparent material so that the pattern at the outer surface of the inner bottle can be viewed from an outer side of the outer bottle; and a gel layer or a liquid layer being filled in the hollow space between the inner bottle and outer bottle. The cover with the same structure as the bottle is also included.

### FIELD OF THE INVENTION

The present invention relates to bottles, and particularly to a decorating bottle, wherein the gel or liquid filled between the inner bottle (or inner cover) and outer bottle (outer cover) so as to expand the pattern on the outer surface of the inner bottle to present a beautiful and charming outlook. Furthermore air or decorations can be placed in the gel or liquid layer which further increase the beauty of the structure.

### BACKGROUND OF THE INVENTION

Referring to FIGS. 10 and 11, the prior art bottle body is illustrated. The prior art bottle body includes an inner bottle 91, an outer bottle 92 enclosing the inner bottle 91, and an inner surface of the outer bottle 92 having patterns. A hollow space 93 is formed between the outer bottle 92 and inner bottle 91. The outer bottle 92 is made of transparent material so that the pattern in the inner surface of the outer bottle 92 can be viewed and the volume of the object filled in the inner bottle 91 can be reduced effective.

However, this prior art has a defect that the pattern is on an inner surface of the outer bottle 92 so that the cross section of the transparent material of the outer bottle 92 can be viewed, as illustrated in FIG. 11. If the pattern is directly coated upon an outer surface of the outer bottle 92, the beautiful transparent effect can not be presented.

### SUMMARY OF THE INVENTION

Accordingly, the primary object of the present invention is to provide a decorating bottle, wherein the gel or liquid filled between the inner bottle (or inner cover) and outer bottle (outer cover) so as to expand the pattern on the outer surface of the inner bottle to present a beautiful and charming outlook. Furthermore air or decoration can be placed in the gel or liquid layer which further increases the beauty of the structure.

To achieve above objects, the present invention provides a decorating bottle capable of expanding patterns on an inner bottle body comprising: an inner bottle having a pattern at an outer surface thereof; an outer bottle at an outer side of the inner bottle; a hollow space being formed between the inner bottle and the outer bottle; the outer bottle made of transparent material or semi-transparent material so that the pattern at the outer surface of the inner bottle can be viewed from an outer side of the outer bottle; and a gel layer (or a liquid layer) being filled in the hollow space between the inner bottle and outer bottle.

Furthermore the present invention relates to a decorating cover capable of expanding patterns on an inner cover body comprising: an inner cover having a pattern at an outer surface thereof; an outer cover at an outer side of the inner cover; a hollow space being formed between the inner cover and the outer cover; the outer cover made of transparent material or semitransparent material so that the pattern at the outer surface of the inner cover can be viewed from an outer side of the outer cover; and a gel layer (or a liquid layer) being filled in the hollow space between the inner cover and outer cover.

The various objects and advantages of the present invention will be more readily understood from the following detailed description when read in conjunction with the appended drawing.

### BRIEF DESCRIPTION OF THE DRAWINGS

FIGS. 1 and 1(A) are perspective view and cross sectional view about the bottle body of the present invention.

FIG. 2 is a schematic view about the bottle body of the present invention, where gel or liquid is filled therein.

FIGS. 3 and 3(A) are cross sectional views showing that the outer bottom of the inner bottle is separated from an inner bottom of the outer bottle.

FIGS. 4 and 4(A) are perspective view and cross sectional view of the cover of the present invention, where no gel or liquid is filled in the hollow space.

FIG. 5 is a cross sectional view of the bottle body of the present invention, where gel or liquid has been filled into the hollow space of the cover.

FIGS. 6 and 6(A) are cross sectional views showing that the outer bottom of the inner cover is separated from an inner bottom of the outer cover.

FIGS. 7 and 7(A) are schematic views showing that air is filled into the gel or liquid in the hollow space of a bottle body or a cover according to the present invention.

FIGS. 8 and 8(A) are schematic view showing that decorations are placed into the gel or liquid in the hollow space of a bottle body or a cover according to the present invention.

FIG. 9 shows the flow diagram about the method of the present invention.

FIGS. 10 and 11 shows the prior art bottle.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

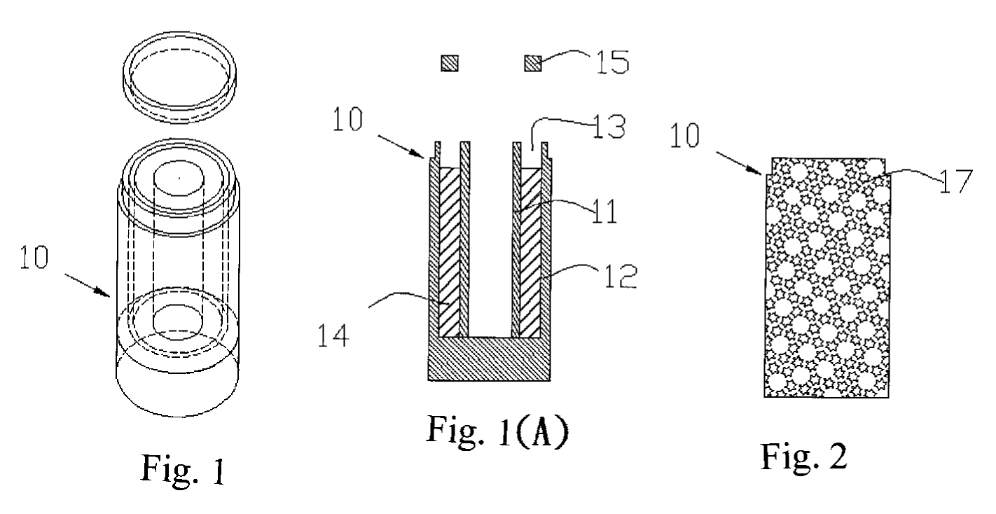

Referring to FIGS. 1, 1(A) and 2, the structure of the present invention is illustrated. The present invention has the following elements.

An inner bottle 11 has a pattern at an outer surface thereof.

An outer bottle 12 is at an outer side of the inner bottle 11. A hollow space 13 is formed between the inner bottle 11 and the outer bottle 12. The outer bottle 12 is made of transparent material or semi-transparent material so that the pattern at the outer surface of the inner bottle 11 can be viewed from an outer side of the outer bottle 12.

A gel layer 14 (or a liquid layer) is filled in the hollow space 13 between the inner bottle 11 and outer bottle 12.

In this embodiment, a sealing ring 15 can be placed between the inner bottle 11 and outer bottle 12 and above the gel layer 14 (or liquid layer) so as to seal the gel (or liquid) not to drain out.

Referring to FIGS. 1 and 1(A), an appearance of the bottle of the present invention is illustrated, where no gel (or liquid) is filled in the hollow space 13. Thus the hollow space 13 can be viewed from the outer side of the bottle.

Referring to FIG. 2, when the gel (or liquid) is filled into the hollow space 13 and light passes through the bottle body, it is illustrated that the pattern will expand to occupy the full outer surface of the outer bottle 12 and thus the hollow space 13 and inner bottle 11 cannot be sensed by viewers.

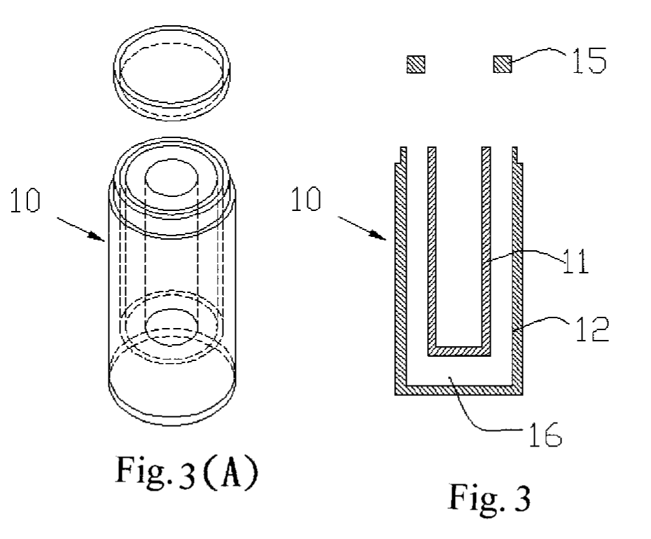

With reference to FIGS. 3 and 3(A), another embodiment of the present invention is illustrated, where it is illustrated that a lower bottom of the inner bottle 11 is separated from inner bottom of the outer bottle 12 so that a gap 16 is formed between the outer bottom of the inner bottle 11 and the inner bottom of the outer bottle 12. However, the present invention can be used to such kind of bottle.

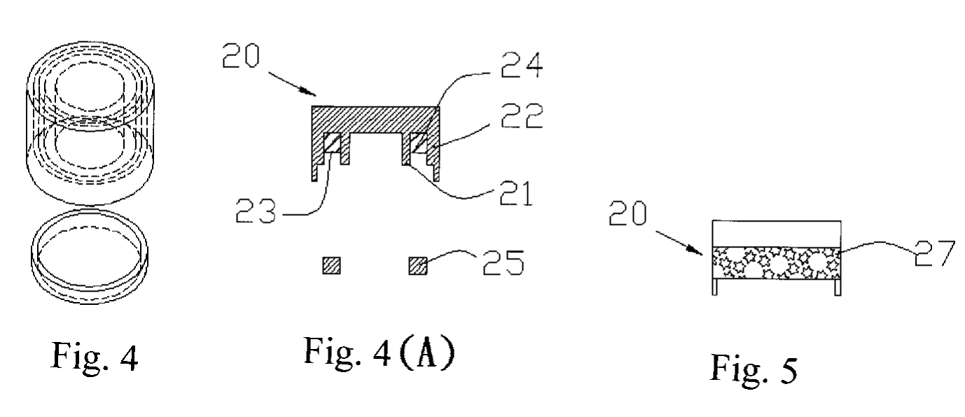

Referring to FIGS. 4 and 4(A), it is illustrated that the present invention can be used to a cover. The cover includes the following elements.

An inner cover 21 has a pattern at an outer surface thereof.

An outer cover 22 is at an outer side of the inner cover 21. A hollow space 23 is formed between the inner cover 11 and the outer cover 12. The outer cover 22 is made of transparent material or semi-transparent material so that the pattern at the outer surface of the inner cover 21 can be viewed from an outer side of the outer cover 22.

A gel layer 24 (or a liquid layer) is filled in the hollow space 23 between the inner cover 21 and outer cover 22.

In this embodiment, a sealing ring 25 can be placed between the inner cover 21 and outer cover 22 and above the gel layer 24 (or liquid layer) so as to seal the gel (or liquid) not to drain out.

Referring to FIG. 5, when the gel (or liquid) is filled into the hollow space 23 and light passes through the cover body, it is illustrated that the pattern will expand to occupy the full outer surface of the outer cover 22 and thus the hollow space 23 and inner cover 21 cannot be sensed by viewers.

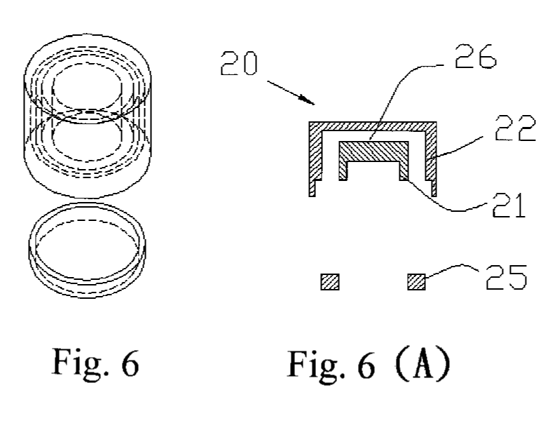

With reference to FIGS. 6 and 6(A), another embodiment of the present invention is illustrated, where it is illustrated that an outer bottom of the inner cover 21 is separated from inner bottom of the outer cover 22 so that a gap 26 is formed between the outer bottom of the inner cover 21 and the inner bottom of the outer cover 22. However, the present invention can be used to such kind of covers.

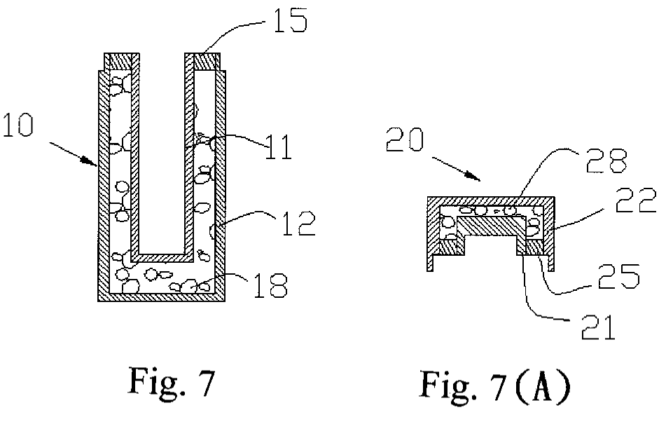

Referring to FIGS. 7 and 7(A), in the present invention, the gel (or liquid) in the hollow space 13 can be mixed by air 18 (FIG. 7) and air 28 (FIG. 7(A)) so as to have the effect of air bubble in the hollow space.

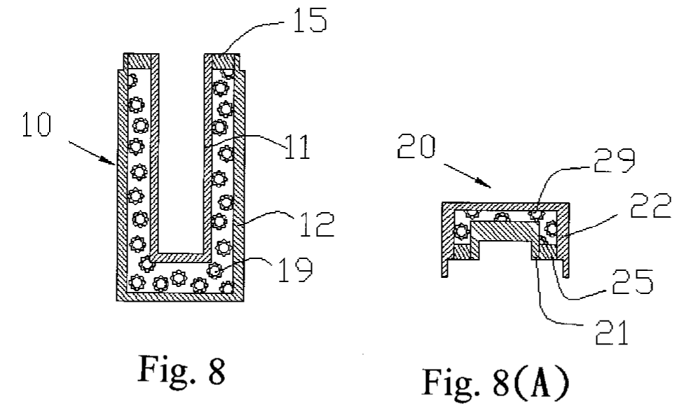

Referring to FIGS. 8 and 8(A), in the present invention, the gel (or liquid) in the hollow space 13 can be mixed by air 19 (FIG. 8) and air 29 (FIG. 8(A)) so as to have the effect of air bubble in the hollow space.

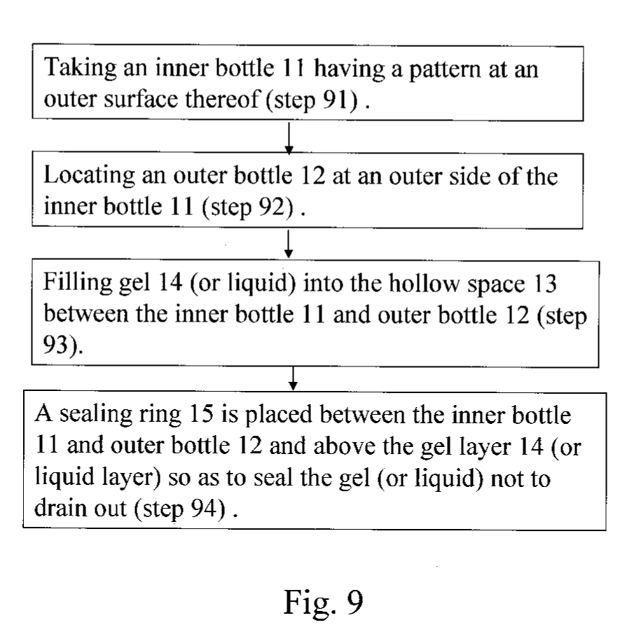

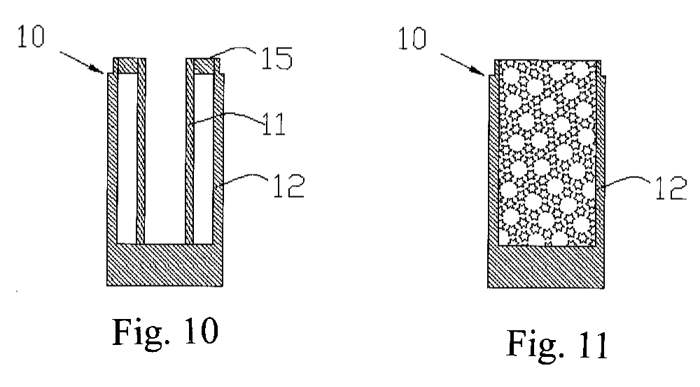

Referring to FIG. 9, a method for expanding a pattern on an outer surface of an inner bottle of a bottle body is illustrated. The method includes the following steps:

Taking an inner bottle 11 having a pattern at an outer surface thereof (step 91).

Locating an outer bottle 12 at an outer side of the inner bottle 11 (step 92); wherein a hollow space 13 is formed between the inner bottle 11 and the outer bottle 12; the outer bottle 12 is made of transparent material or semi-transparent material so that the pattern at the outer surface of the inner bottle 11 can be viewed from an outer side of the outer bottle 12; and

Filling gel 14 (or liquid) into the hollow space 13 between the inner bottle 11 and outer bottle 12 (step 93).

In this embodiment, a sealing ring 15 can be placed between the inner bottle 11 and outer bottle 12 and above the gel layer 14 (or liquid layer) so as to seal the gel (or liquid) not to drain out (step 94);

Installing a sealing ring between the inner bottle 11 and outer bottle 12 and above the gel layer 14 (or liquid layer) so as to seal the gel (or liquid) not to drain out.

Furthermore a method for expanding a pattern on an outer surface of an inner cover of a cover body is illustrated. The method includes the following steps:

Taking an inner cover 21 having a pattern at an outer surface thereof.

Locating an outer cover 22 at an outer side of the inner cover 21; wherein a hollow space 23 is formed between the inner cover 21 and the outer cover 22; the outer cover 22 is made of transparent material or semi-transparent material so that the pattern at the outer surface of the inner cover 21 can be viewed from an outer side of the outer cover 22;

Filling gel 24 (or liquid) into the hollow space 23 between the inner cover 21 and outer cover 22;

In this embodiment, a sealing ring 25 can be placed between the inner cover 21 and outer cover 22 and above the gel layer 24 (or liquid layer) so as to seal the gel (or liquid) not to drain out;

Installing a sealing ring 25 between the inner cover 21 and outer cover 22 and above the gel layer 24 (or liquid layer) so as to seal the gel (or liquid) not to drain out.

Moreover, air can be filled into the gel or air.

Moreover, decorations can be placed in the gel or liquid.

Advantages of the present invention will be described herein. The gel or liquid filled between the inner bottle (or inner cover) and outer bottle (outer cover) so as to expand the pattern on the outer surface of the inner bottle to present a beautiful and charming outlook. Furthermore air or decoration can be placed in the gel or liquid layer which further increases the beauty of the structure.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A decorating bottle capable of expanding patterns on an inner bottle body comprising:
an inner bottle having a pattern at an outer surface thereof;
an outer bottle at an outer side of the inner bottle; a hollow space being formed between the inner bottle and the outer bottle; the outer bottle being made of transparent material or semi-transparent material so that the pattern at the outer surface of the inner bottle can be viewed from an outer side of the outer bottle; and
a gel layer or a liquid layer being filled in the hollow space between the inner bottle and outer bottle.

2. The decorating bottle as claimed in claim 1, further comprising:
a sealing ring placed between the inner bottle and outer bottle and above the gel layer or liquid layer so as to seal the gel or liquid not to drain out.

3. The decorating bottle as claimed in claim 1, wherein air is contained in the gel or liquid.

4. The decorating bottle as claimed in claim 1, wherein decorations are contained in the gel or liquid.

5. The decorating bottle as claimed in claim 1, wherein a lower bottom of the inner bottle is separated from inner bottom of the outer bottle so that a gap is formed between the outer bottom of the inner bottle and the inner bottom of the outer bottle.

6. A decorating cover capable of expanding patterns on an inner cover body comprising:
an inner cover having a pattern at an outer surface thereof.
an outer cover at an outer side of the inner cover; a hollow space being formed between the inner cover and the outer cover; the outer cover being made of transparent material or semi-transparent material so that the pattern at the outer surface of the inner cover can be viewed from an outer side of the outer cover; and
a gel layer or a liquid layer being filled in the hollow space between the inner cover and outer cover.

7. The decorating cover as claimed in claim 1, further comprising:
a sealing ring placed between the inner cover and outer cover and above the gel layer or liquid layer so as to seal the gel or liquid not to drain out.

8. The decorating cover as claimed in claim 1, wherein air is contained in the gel or liquid.

9. The decorating cover as claimed in claim 1, wherein decorations are contained in the gel or liquid.

10. The decorating cover as claimed in claim 1, wherein a lower bottom of the inner cover is separated from inner bottom of the outer cover so that a gap is formed between the outer bottom of the inner cover and the inner bottom of the outer cover.

11. A method for forming decorating bottle capable of expanding patterns on an inner bottle body comprising steps of:
taking an inner bottle having a pattern at an outer surface thereof;
locating an outer bottle at an outer side of the inner bottle; wherein a hollow space is formed between the inner bottle and the outer bottle; the outer bottle is made of transparent material or semi-transparent material so that the pattern at the outer surface of the inner bottle can be viewed from an outer side of the outer bottle; and
filling gel or liquid into the hollow space between the inner bottle and the outer bottle.

12. The method of claim 11, further comprising the step of: installing a sealing ring between the inner bottle and outer bottle and above the gel layer or liquid layer so as to seal the gel or liquid not to drain out.
